(19) United States
(12) Patent Application Publication
(10) Pub. No.: US 2010/0286014 A1
(43) Pub. Date: Nov. 11, 2010

(54) LOW PH POST-CMP RESIDUE REMOVAL COMPOSITION AND METHOD OF USE

(75) Inventor: Jeffrey A. Barnes, New Milford, CT (US)

Correspondence Address: MOORE & VAN ALLEN PLLC, P.O. BOX 13706, Research Triangle Park, NC, 27709, US

(73) Assignee: ADVANCED TECHNOLOGY MATERIALS, INC., Danbury, CT (US)

(21) Appl. No.: 12/278,164

(22) PCT Filed: Feb. 5, 2007
(86) PCT No.: PCT/US07/61588

§ 371 Date: Aug. 2, 2010

Related U.S. Application Data
(60) Provisional application No. 60/764,972, filed on Feb. 3, 2006.

(51) Int. Cl. C11D 7/34

(52) U.S. Cl. 510/175

(57) ABSTRACT

An acidic composition and process for cleaning post-chemical mechanical polishing (CMP) residue and contaminants from a microelectronic device having said residue and contaminants thereon. The acidic composition includes surfactant, dispersing agent, sulfonic acid-containing hydrocarbon, and water. The composition achieves highly efficacious cleaning of the post-CMP residue and contaminant material from the surface of the microelectronic device without compromising the low-k dielectric material or the copper interconnect material.

### FIELD OF THE INVENTION

The present invention relates to acidic compositions for cleaning residue and/or contaminants from microelectronic devices having same thereon.

### DESCRIPTION OF THE RELATED ART

As semiconductor device geometries continue to shrink to less than 0.18 μm, more emphasis has been placed on improved, interconnect structures to minimize resistance-capacitance (RC) delays. Strategies to minimize interconnect delays include improving conductivity of the interconnect metal and lowering the dielectric constant (k) value of the dielectric layers. For example, copper has emerged as a replacement for conventional aluminum as the interconnect metal in advanced devices. Copper is more conductive than aluminum (thus reducing resistance-capacitance time delays) and also is less subject to electromigration when compared to conventional Al metallization.

In the manufacturing of deep submicron semiconductors, the copper damascene process is used to form conductive copper lines and vias in the low-k dielectric layer. One important step of the damascene process is copper chemical mechanical, polishing (CMP) for the removal of excess copper above the dielectric layer surface.

The CMP process involves holding and rotating a thin, flat substrate of the semiconductor device against a wetted polishing pad under controlled pressure and temperature in the presence of CMP slurries. The slurries contain abrasive materials and chemical additives as appropriate to the specific CMP process and requirements. Following the CMP process, contaminants consisting of particles from the polishing slurry, chemicals added to the slurry, and reaction, by-products of the polishing slurry are left behind on the wafer surface. In addition, the polishing of a copper/low dielectric constant material on a silicon wafer often generates carbon-rich particles that settle onto the wafer surface after polishing. All contaminants must be removed prior to any further steps in the microelectronic device fabrication process to avoid degradation of device reliability and introduction of defects into the device. Often, particles, of these contaminants are smaller than 0.3 μm.

Conventional cleaning techniques use fluid flow of a cleaning solution, e.g., alkaline solutions based on ammonium hydroxide, over the wafer surface in combination with megasonics, jetting or brushing to remove contaminants. Said cleaning solutions remove the contaminants by attacking the wafer surface or reacting with the contaminants before removing the dislodged contaminants from the wafer. Disadvantageously, some of the contaminants may be chemically inert to the chemical ingredients in the cleaning solutions. Furthermore, the amine-containing cleaning solutions known in the art smell and release amine vapors into the fab which can poison photoresist. In addition, generally the cleaning solution preferably has a pH that is similar to the pH of the CMP slurry used. As such, alkaline cleaning solutions have a limited usefulness.

It would be a significant advance in the art to provide improved acidic compositions for post-CMP cleaning of the microelectronic devices, for the defect-free and scratch-free removal of CMP residue and contaminants from the surface of said device. Said aqueous compositions effectuate substantial residue and contaminant removal from the surface of the device without damaging the exposed low-k dielectric, material and interconnect and via materials, e.g., copper and/or aluminum containing materials.

### SUMMARY OF THE INVENTION

The present invention generally relates to an acidic composition and process for cleaning residue and/or contaminants from microelectronic devices having said residue and contaminants thereon. The acidic cleaning compositions of the invention include at least one surfactant, at least one dispersing agent, at least one sulfonic acid-containing hydrocarbon, and the balance water. Optionally, the acidic cleaning composition may further include at least one complexing agent. The residue may include post-CMP residue.

One aspect of the invention relates to an acidic, composition comprising at least one surfactant, at least one dispersing agent, at least one sulfonic acid-containing hydrocarbon, and water, wherein said acidic composition is suitable for cleaning residue and contaminants from a microelectronic device having said residue and contaminants thereon.

Another aspect of the invention relates to an acidic composition consisting essentially of at least one surfactant, at least one dispersing agent, at least one sulfonic acid-containing hydrocarbon, and water, wherein said acidic composition is suitable for cleaning residue and contaminants from a microelectronic device having said residue and contaminants thereon.

Still another aspect of the invention relates to an acidic composition consisting of at least one surfactant, at least one dispersing agent, at least one sulfonic acid-containing hydrocarbon, and water, wherein said acidic composition is suitable for cleaning residue and contaminants, from a microelectronic device having said residue and contaminants thereon.

Yet another aspect of the invention relates to an acidic composition comprising at least one surfactant, at least one dispersing agent, at least one sulfonic acid-containing hydrocarbon, at least one complexing agent, and water, wherein said acidic composition, is suitable for cleaning residue and contaminants from a microelectronic device having said residue and contaminants thereon.

In yet another aspect, the invention relates to an acidic composition consisting essentially of at least one surfactant, at least one dispersing agent, at least one sulfonic acid-containing hydrocarbon, at least one complexing agent, and water, wherein said acidic composition is suitable for cleaning residue and contaminants from a microelectronic device having said residue and contaminants thereon.

Still another aspect of the invention relates to an acidic composition consisting of at least one surfactant, at least one dispersing agent, at least one sulfonic acid-containing hydrocarbon, at least one complexing agent, and watery wherein said acidic composition is suitable for cleaning residue and contaminants from a microelectronic device having said residue and contaminants thereon.

In another aspect, the invention relates to a kit comprising, in one or more containers, two or more of the following reagents for forming an acidic composition, said two or more reagents selected from the group consisting of at least one surfactant, at least one dispersing agent, at least one sulfonic acid-containing hydrocarbon, optionally at least one complexing agent, and water, and wherein the kit is adapted to form an acidic composition suitable for cleaning post-CMF residue and contaminants from a microelectronic device having said residue and contaminants thereon.

In yet another aspect, the present invention relates to a method of cleaning residue and contaminants from a microelectronic device having said residue and contaminants thereon, said method, comprising contacting the microelectronic device with an acidic composition for sufficient time to at least partially clean said residua and contaminants from the microelectronic device, wherein the acidic composition includes at least one surfactant, at least one dispersing agent, at least one sulfonic mid-containing hydrocarbon, and water.

In another aspect, the present invention relates to a method of removing post-CMP residue and contaminants from a microelectronic device having same thereon, said method comprising:
polishing the microelectronic device with a CMP slurry;
contacting the microelectronic device with an acidic composition comprising at least one surfactant, at least one dispersing agent, at least one sulfonic acid-containing hydrocarbon, optionally at least one complexing agent, and water, for a sufficient time to remove post-CMP residue and contaminants from the microelectronic device to the acidic composition to form a post-CMP residue-containing acidic composition; and
continuously contacting the microelectronic device with the post-CMP residue-containing acidic composition for a sufficient amount of time to effect substantial cleaning of the microelectronic device.

In Still another aspect, the present invention relates to a method of cleaning a microelectronic device having residue and contaminants thereon, said method comprising contacting the microelectronic, device with an acidic composition for sufficient time to remove residue and contaminants from the microelectronic device haying same thereon, wherein said, acidic composition comprises at least one cleaning concentrate and water and said cleaning concentrate comprises at least one surfactant, at least one dispersing agent, at least one sulfonic acid-containing hydrocarbon, and optionally at least one complexing agent.

In still another aspect, the present invention relates to a method of cleaning a microelectronic device having post-CMP residue and contaminants thereon, said method comprising contacting the microelectronic device with an acidic composition for sufficient time to remove post-CMP residue and contaminants from the microelectronic device having same thereon, wherein said acidic composition comprises at least one cleaning concentrate and water and said cleaning concentrate comprises at least one surfactant, at least one dispersing agent, at least one sulfonic acid-containing hydrocarbon, and optionally at least one complexing agent.

In a further aspect, the present invention relates to a method of manufacturing a microelectronic device, said method comprising contacting the microelectronic device with an acidic cleaning composition described herein for sufficient time to at least partially clean post-CMP residue and contaminants from the microelectronic device having said residue and contaminants thereon.

Yet another aspect of the invention relates to improved microelectronic devices, and products incorporating same, made using, the methods of the invention comprising cleaning of post-CMP residue and contaminants from the microelectronic device having said residue and contaminants thereon, using the methods and/or compositions described herein, and optionally, incorporating the microelectronic device into a product.

Another aspect of the invention relates to an article of manufacture comprising an acidic cleaning composition, a microelectronic device wafer, and post-CMP residue and contaminants, wherein the acidic cleaning composition comprises at least one surfactant, at least one dispersing agent, at least one sulfonic acid-containing hydrocarbon, and optionally at least one complexing agent.

Other aspects, features and advantages of the invention will be more fully apparent from the ensuing, disclosure and appended claims.

### BRIEF DESCRIPTION OF THE DRAWINGS

FIG. 1 is an atomic force microscopy (AFM) image of a Sematech 854 wafer contaminated with post-CMP residue before cleaning the wafer with an acidic cleaning composition of the present invention.

FIG. 2 is an AFM image of the Sematech 854 wafer of FIG. 1 after cleaning the wafer with a 0.75% citric acid solution.

FIG. 3 is an AFM image of the Sematech 854-wafer of FIG. 1 after cleaning the wafer with a cleaning composition including 0.44 wt. % Formulation B.

FIG. 4 is an AFM image of the Sematech 834 wafer of FIG. 1 after cleaning the wafer with a cleaning composition including 0.07 wt. % Formulation A.

### DETAILED DESCRIPTION OF THE INVENTION AND PREFERRED EMBODIMENTS THEREOF

The present invention relates generally to acidic compositions that clean post-CMP residue and contaminants from a microelectronic device having such material(s) thereon.

For ease of reference, “microelectronic, device” corresponds to semiconductor substrates, flat panel displays, phase change memory devices, and microelectromechanical systems (MEMS), manufactured for use in microelectronic, integrated circuit, or computer chip applications. It is to be understood that the term “microelectronic device” is not meant to be limiting in any way and includes any substrate that will eventually become a microelectronic device or microelectronic assembly.

As used herein, “residue” corresponds to particles generated during the manufacture of a microelectronic device including, but not limited to, plasma etching, ashing, chemical mechanical polishing, wet etching, and combinations thereof.

As used herein, “contaminants” correspond to chemicals present in the CMP slurry, reaction by-products of the polishing slurry, and any other materials that are the by-products of the CMP process.

As used herein, “post-CMP residue” corresponds to particles from the polishing slurry, e.g., silica-containing particles, chemicals present in the slurry, reaction by-products of the polishing slurry, carbon-rich particles, polishing pad particles, copper, copper oxides, and any other materials that are the by-products of the CMP process.

As defined herein, “low-k dielectric material” corresponds to any material used, as a dielectric material in a layered microelectronic device, wherein the material has a dielectric constant less than about 3.5. Preferably, the low-k dielectric materials include low-polarity materials such as silicon-containing organic polymers, silicon-containing hybrid organic/inorganic materials, organosilicate glass (OSG), TEOS, fluorinated silicate glass (FSG), silicon dioxide, and carbon-doped oxide (CDO) glass. It is to be appreciated that the low-k dielectric materials may have varying densities and varying porosities.

As defined herein, “clean acidic compositions” correspond to the acidic compositions just prior to contact with the microelectronic device having post-CMP and/or contaminants thereon.

As defined herein, “complexing agent” includes those compounds that are understood by one skilled in the art to be complexing agents, chelating agents and/or sequestering agents. Complexing agents will chemically combine with or physically hold the metal atom and/or metal ion to be removed using the compositions of the present invention.

As used herein, “about” is intended to correspond to ±5% of the stated value.

As used herein, “suitability” for cleaning post-CMP residue and contaminants from a microelectronic device having said residue and contaminants thereon corresponds to at least partial removal of said residue/contaminants from the microelectronic device. Preferably, between 50 and 85% of the residue/contaminants are removed from the microelectronic device using the compositions of the invention, more preferably at least 90%, even more preferably at least 95%, and most preferably at least 99% of the residue/contaminants are removed.

Compositions of the invention may be embodied in a wide variety of specific formulations, as hereinafter more fully described.

In all such compositions, wherein specific components of the composition are discussed in reference to weight percentage ranges including a zero lower limit, it will be understood that such components may be present or absent in various specific embodiments of the composition, and that in instances where such components are present, they may be present at concentrations as low as 0.001 weight percent, based on the total weight of the composition in which such components are employed.

In one aspect, the present invention relates to an acidic composition for cleaning post-CMP residue and contaminants, said composition including at least one surfactant, at least one dispersing agent, at least one sulfonic acid-containing hydrocarbon, and the balance water. Optionally, the acidic composition may further comprise at least one completing agent. The components in the acidic composition are present in the following range of weight percent ratios, relative to the sulfonic-acid containing hydrocarbon, with the balance of the composition being water:

| | Weight percent ratio | preferred wt. % ratio |
|---|---|---|
| component | range | range |
| surfactant(s) | about 0.01 to about 1 | about 0.05 to about 0.4 |
| dispersing agent(s) | about 0.01 to about 1.6 | about 0.1 to about 0.75 |
| sulfonic acid- | 1 | 1 |
| containing | | |
| hydrocarbon(s) | | |
| optional complex- | 0 to about 30 | 2 to about 15 (when |
| ing agent(s) | | present) |

Put another way, the amount of surfactants), dispersing agent(s), sulfonic acid-containing hydrocarbon(s) and optional complexing agents agent(s) in a concentrated acidic composition, based on the total weight of the composition, is as follows:

| | | | most preferred |
|---|---|---|---|
| components | weight % | preferred weight % | weight % |
| surfactant(s) | about 0.001% to | about 0.02% to about | about 0.1% to about |
| | about 5% | 1% | 0.5% |
| dispersing agent(s) | about 0.001% to | about 0.01% to about | about 0.1% to about |
| | about 5% | 2% | 1% |
| sulfonic acid- | about 0.1% to about | about 0.5% to about | about 1% to about |
| containing | 10% | 5% | 4% |
| hydrocarbon(s) | | | |
| complexing agent(s) | 0 to about 30% | about 1% to about | about 5% to about |
| | | 20% (when present) | 20% (when present) |

Upon dilution, the weight percent values of the components in the concentrated acidic composition will change as a factor of the dilution factor, as readily understood by one skilled in the art.

In the broad practice of the invention, the acidic composition may comprise, consist of, or consist essentially of (i) surfactants), dispersing agent(s), sulfonic acid-containing hydrocarbon(s), and water; or (ii) surfactants), dispersing agent(s), sulfonic acid-containing hydrocarbon(s), complexing agent(s), and water. The water is preferably deionized.

The range of weight percent ratios of the components will cover all possible concentrated or diluted embodiments, of the acidic composition.

In the broad practice of the invention, the pH range of the acidic composition is less than about 7.0, more preferably less than 4.5, still more preferably in a range from about 0 to about 3, and most preferably in a range from about 0.5 to about 2.

The compositions of the present invention may have utility in applications including, but not limited to, post-etch residue removal, post-ash residue removal surface preparations post-plating cleaning and post-CMP residue removal. As defined herein, “post-etch residue” corresponds to material remaining following gas-phase plasma etching processes, e.g., BEOL dual damascene processing. The post-etch residue may be organic, organometallic, organosilicic, or inorganic in nature, for example, silicon-containing material, carbon-based organic material, and etch gas residue including, but not limited to, oxygen and fluorine. “Post-ash residue,” as used herein, corresponds to material remaining following oxidative or reductive plasma ashing to remove hardened photoresist and/or bottom anti-reflective coating (BARC) materials. The post-ash residue may be organic, organometallic, organosilicic, or inorganic in nature.

Preferably, the clean acidic compositions of the invention are devoid of polydioxythiophene, fatty alkyl-1,3-diammopropane or salt thereof, and resin particles such as polymethymethacrylate, polystyrene, polyethylene, polyethylene glycol, polyvinyl acetate, polybutadiene, polyisobutylene, polypropylene and polyoxymethylene.

Illustrative surfactants for use in the present invention include, but are not limited to, amphoteric salts, cationic surfactants, anionic surfactants, fluoroalkyl surfactants, non-ionic surfactants, and combinations thereof including, hut not limited to, SURFONYL® 104, TRITON® CF-2U ZONYL® UR, ZONYL® FSO-100, ZONYL® FSN-100, 3M Fluorad fluorosurfactants (i.e., FC-4430 and FC-4432), dioctylsulfosuccinate salt, 2,3-dimercapto-1-propanesulfonic acid salt, dodecylbenzenesulfonic acid, polyethylene glycols, polypropylene glycols, polyethylene or polypropylene glycol ethers, carboxylic acid salts, R₁ benzene sulfonic acids or salts thereof (where the R₁ is a straight-chained or branched C₈-C₁₈ alkyl group), amphiphilic fluoropolymers, polyethylene glycols, polypropylene glycols, polyethylene or polypropylene glycol ethers, carboxylic acid salts, dodecylbenzenesulfonic acid, polyacrylate polymers, dinonylphenyl polyoxyethylene, silicone or modified silicone polymers, acetylenic diols or modified acetylenic diols, alkylammonium or modified alkylammonium salts, as well as combinations comprising at least one of the foregoing surfactants, sodium dodecyl sulfate, zwitterionic surfactants, aerosol-OT (AOT) and fluorinated analogues thereof, alkyl ammonium, perfluoropolyether surfactants, 2-sulfosuccinate salts, phosphate-based surfactants, sulfur-based surfactants, and acetoacetate-based polymers. In a preferred embodiment, the surfactant includes an alkyl benzene sulfonic acid, more preferably dodecylbenzenesulfonic acid.

The dispersing agent used in the acidic composition of the present invention is included to increase dispersancy and minimize redeposition of the removed residue and contaminants at the surface of the microelectronic device wafer. Dispersing agents contemplated herein include organic polymers containing acrylic acid or its salts having an average molecular weight of less than 15,000, hereinafter referred to as low molecular weight acrylic acid-containing polymer. The low molecular weight acrylic acid-containing polymer has an average molecular weight of less than 15,000, preferably from about 3,000 to about 10,000. The low molecular weight acrylic acid-containing polymer may be either a homopolymer or a copolymer including the essential acrylic acid or acrylic acid salt monomer units. Copolymers may include essentially any suitable, other monomer units including modified acrylic, fumaric, maleic, itaconic, aconitic, mesaconic, citraconic, and methylenemalonic acid or their salts, maleic anhydride, alkylene, vinylmethyl ether, styrene and any mixtures thereof. Preferred commercially available low molecular weight acrylic acid containing homopolymers, include those sold under the tradename Acusol 445 (Rohm and Haas, Philadelphia, Pa., USA).

The sulfonic acid-containing hydrocarbons contemplated herein include straight chain and branched C₁-C₆ alkane, e.g., methane, ethane, propane, butane, pentane, hexane, sulfonic acids, straight chain and branched C₂-C₆ alkene, e.g., ethane, propene, butane, pentene, hexane, sulfonic acids, and substituted or unsubstituted C₆-C₁₄ aryl sulfonic acids, and salts thereof, e.g., sodium, potassium, etc. Sulfonic acid-containing hydrocarbons include methanesulfonic acid, ethanesulfonic acid, propanesulfonic acid, butanesulfonic acid, pentanesulfonic acid, hexanesulfonic acid, ethenesulfonic acid, toluenesulfonic acid, and combinations thereof.

The optional complexing agents contemplated herein include organic acids, comprising at least one COOH group or carboxylate group in a salt thereof, including, hut not limited to, lactic acid, maleic acid, ascorbic acid, malic acid, citric acid, benzoic acid, fumaric acid, succinic acid, oxalic acid, malonic acid, mandelic acid, maleic anhydride, phthalic acid, aspartic acid, glutamic acid, glutaric acid, glycolic acid, glyoxylic acid, itaconic acid, phenylacetic acid, quinic acid, pyromellitic acid, tartaric acid, terephthalic acid, trimellitic acid, trimesic acid, gluconic acid, glyceric acid, formic acid, acetic acid, propionic acid, acrylic acid, adipic acid, itaconic acid, glycine, lysine, pyrocatecol, pyrogallol, gallic acid, tannic acid, other aliphatic and aromatic carboxylic acids, salts thereof as well as combinations of the foregoing acids. Preferably, the organic acid includes citric acid.

In addition, the acidic composition may further include co-solvent(s), strong acid(s), etc.

In a preferred embodiment, the acidic composition of the invention includes, methanesulfonic acid, dodecylbenzenesulfonic acid, and polyacrylic acid.

The acidic composition may be formulated in the following formulations, wherein the active ingredients in the formulations are at the following weight percentratios, relative to methanesulfonic acid, to be used in an aqueous solution:

### Formulation A

| | |
|---|---|
| Methanesulfonic acid | 1 |
| Dodecylbenzenesulfonic acid | 0.1 |
| Acusol 445 | 0.23 |

### Formulation B

| | |
|---|---|
| Methanesulfonic acid | 1 |
| Dodecylbenzenesulfonic acid | 0.2 |
| Acusol 445 | 0.31 |
| Citric acid | 10 |

### Formulation C

| | |
|---|---|
| Methanesulfonic acid | 1 |
| Dodecylbenzenesulfonic acid | 0.2 |
| PAA (Sokalon 10S) | 0.44 |
| Citric acid | 10 |

### Formulation D

| | |
|---|---|
| Methanesulfonic acid | 1 |
| Dodecylbenzenesulfonic acid | 0.2 |
| PAA (Sokalon 10S) | 0.67 |
| Citric acid | 10 |

In one embodiment of the invention, a concentrated acidic composition is provided that can be diluted for use as a cleaning, solution. A concentrated composition, or “concentrate,” advantageously permits, a user, e.g. CMP process engineer, to dilute the concentrate to the desired strength and acidity at the point of use. Dilution of the concentrated cleaning composition may be in a range from about 1:1 to about 2500:1, wherein the cleaning composition is diluted at or just before the tool with solvent, e.g., deionized water. It is to be appreciated by one skilled in the art that, following dilution, the fangs of weight percent ratios of the components disclosed herein should remain unchanged.

For example, in a further preferred embodiment, Formulations A and B may be diluted with water as follows to obtain the weight percentages of total active ingredients before or at the point of use.

| % wt. Formulation | % wt. water |
|---|---|
| about 0.3% to about 1.0% Formulation B | about 99% to about 99.7% |
| about 0.04% to about 0.15% Formulation A | about 99.85% to 99.96% |
| about 0.01% to about 1.0% Formulation C | about 99.99% to about 99% |

Preferably, the pH of the concentrate is in a range from about 0.5 to about 2, preferably about 0.5 to about 1.5 and the pH of the diluted formulation is in a range from about 0.5 to about 3, more preferably about 1 to about 3, and most preferably about 1.5 to about 2.5.

An important feature of the acidic composition of the invention is that the non-aqueous constituents (the constituents other than water) are present in the composition in small quantities, often less than about ID % by weight. This is an economic advantage since an effective acidic composition can be formulated more economically, which is of importance since post-CMP acidic compositions are used in large quantities. Furthermore, because the acidic composition is water-based, the acidic compositions of the invention are more easily disposed of. Notably, the life of the acidic composition is dependent only on particle loading and as such, the acidic composition is recyclable.

In yet another preferred embodiment, the acidic compositions of the present invention comprise, consist of, or consist essentially of at least one surfactant, at least one dispersing agent, at least one sulfonic acid-containing hydrocarbon, residue and/or contaminants, optionally at least one completing agent, and the balance water. Importantly, the residue and contaminants may be dissolved and/or suspended in the acidic composition of the invention. Preferably, the residue includes post-CMP residue.

According to the Merck Index, methanesulfonic acid is corrosive to copper (Merck Index, 11^{th} ed., 1989, pg 938). Surprisingly, the acidic compositions of the present invention comprising methanesulfonic acid do not readily corrode exposed copper, aluminum and/or tungsten interconnect material. Furthermore, the dielectric material, including low-k dielectric material Such as TEOS, BLACK DIAMOND™, and other ultra low-k dielectric materials, on the microelectronic device is not compromised by the acidic compositions of the invention.

The acidic compositions of the invention are easily formulated by simple addition of the respective ingredients and mixing to homogeneous condition. Furthermore, the acidic compositions may be readily formulated as single-package formulations or multi-part formulations that are mixed at or before the point of use, e.g., the individual parts of the multi-part formulation may be mixed at the tool or in a storage tank upstream of the tool. The Concentrations of the respective ingredients may be widely varied in specific multiples of the acidic composition, i.e., more dilute or more concentrated, in the broad practice of the invention, and it will be appreciated that the acidic compositions of the invention can variously and alternatively comprise, consist or consist essentially of any combination of ingredients consistent with the disclosure herein.

Accordingly, another aspect of the invention relates to a kit including, in one or more containers, one or more components adapted to form the compositions of the invention. Preferably, the kit includes, in one or more containers, at least one surfactant, at least one dispersing agent, at least one sulfonic acid-containing hydrocarbon, optionally at least one complexing agent, and water, for combining with additional water at the fab or the point of use. The containers of the kit must be suitable for storing and shipping said removal composition components, for example, NOWPak® containers (Advanced Technology Materials, Inc., Danbury, Conn., USA).

As applied to microelectronic manufacturing operations, the acidic compositions of the present invention are usefully employed to clean post-CMP residue and contaminants from the surface of the microelectronic, device. Importantly, the acidic compositions of the invention do not damage low-k dielectric materials or corrode metal interconnects on the device surface. Preferably the acidic compositions remove at least 85% of the residue present on the device prior to residue removal, more preferably at least 90%, even more preferably at least 95%, and most preferably at least 99%.

In post-CMP residue and contaminant cleaning application, the acidic composition may be used with, a large variety of conventional cleaning tools such as megasonics and brush scrubbing, including, but not limited to, Verteq single wafer megasonic Goldfinger, OnTrak systems DDS (double-sided scrubbers), SEZ single wafer spray rinse, Applied Materials Mirra-Mesa™/Reflexion™/Reflexion LK™, and Megasonic batch wet bench systems.

In use of the compositions of the invention for cleaning post-CMP residue and contaminants from microelectronic devices having same thereon, the acidic composition typically is contacted with the device for a time of from about 5 sec to about 10 minutes, preferably about 15 sec to 5 min, at temperature in a range of from about 20° C. to about 50° C. Such contacting times and temperatures are illustrative, and any other suitable time and temperature conditions may be employed that are efficacious to at least partially clean the post-CMP residue/contaminants from the device, within the broad practice of the invention. “At least partially clean” and “substantial removal” both correspond to at removal of at least 85% of the residue present on the device prior to residue removal, more preferably at least 90%, even more preferably at least 95%, and most preferred at least 99%

Following the achievement of the desired cleaning action, the acidic composition may be readily removed from the device to which it has previously been applied, as may be desired and efficacious in a given end use application of the compositions of the present invention. Preferably, the rinse solution includes deionized water. Thereafter, the device may be dried using nitrogen or a spin-dry cycle.

Yet another aspect of the invention relates to the improved microelectronic devices made according to the methods of the invention and to products containing such microelectronic devices.

Another aspect of the invention relates to a recycled acidic composition, wherein the acidic composition includes at least one surfactant, at least one dispersing agent, at least one sulfonic acid-containing hydrocarbon, optionally at least one completing agent, water, and residue and/or contaminants. An acidic composition of the invention may be recycled until residue and/or contaminant loading reaches the maximum amount the acidic composition may accommodate, as readily determined by one skilled in the art.

A still further aspect of the invention relates to methods of manufacturing an article comprising a microelectronic device, said method comprising contacting the microelectronic device with an acidic composition for sufficient time to clean post-CMP residue and contaminants from the microelectronic device having said residue and contaminants thereon, and incorporating said microelectronic device into said article, wherein the acidic composition includes at least one surfactant, at least one dispersing agent, at least one sulfonic acid-containing hydrocarbon, optionally at least one complexing agent, and the balance water.

The features and advantages of the invention are more fully illustrated by the following non-limiting examples, wherein all parts and percentages are by weight, unless otherwise expressly stated.

### Example 1

The efficacy of formulations A and B for cleaning post-CMP residue and contaminants from a microelectronic device containing same thereon was evaluated 0.07 wt % of formulation A was diluted with, water to form a post-CMP removal solution. 0.44 wt. % and 0.59 wt. % of formulation B were diluted with water to form two additional post-CMP removal solutions. The device was a patterned Sematech 854 wafer polished with a Hitachi CMP slurry comprising silica abrasive. The wafer in each instance was cleaned on a spin/spray tool (Laurell Technologies Corporation, North Wales, Pa., USA) for 60 seconds at 22° C. at 150 rpm with the specific formulation, followed by a 30 second deionized water rinse at 150 rpm and a 30 second spin dry at 2500 rpm.

Following the treatment, the wafer samples were subjected to atomic force microscopy (AFM) to evaluate the cleaning efficacy of the treatment. AFM images were obtained using a Digital Instruments Dimension 5000 (Veeco Instruments, Woodbury, N.Y., USA) scanning probe microscope. For each wafer sample, three random copper pads, located towards the center of the wafers were, selected, for AFM analysis. At each copper pad location, a 20 μm×20 μm region was scanned in tapping mode at a pixel density of 512×512 and a-scan rate of 1.0 Hz.

A Sigma Scan Pro image analysis histogram was used to determine the number of slurry particles on each AFM image. This software works by setting a pixel color intensity threshold to each AFM image to separate the pixels representing the particles from the pixels representing the underlying capper surface, and then performing an object count function.

The results of the particle count for the control wafer and the wafers spin-sprayed with Citric acid, diluted Formulation A and diluted Formulation B are provided in Table 1.

TABLE 1
Results of the particle count of treated and untreated wafers.

| | | | RMS | |
|---|---|---|---|---|
| | | | Roughness | |
| Treatment | wt. % | Location | (nm) | Object Count |
| Untreated | N/A | (a) | 19.7 | 2639* |
| Untreated | N/A | (b) | 16.4 | 3412* |
| Untreated | N/A | (c) | 17.2 | 2211* |
| Citric Acid | 0.75 | (a) | 11.5 | 4722 |
| Citric Acid | 0.75 | (b) | 10.9 | 5855 |
| Citric Acid | 0.75 | (c) | 11.3 | 4424 |
| Formulation A | 0.08 | (a) | 2.43 | 192 |
| Formulation A | 0.08 | (b) | 1.85 | 137 |
| Formulation A | 0.08 | (c) | 2.77 | 229 |
| Formulation B | 0.59 | (a) | 2.08 | 149 |
| Formulation B | 0.59 | (b) | 2.05 | 225 |
| Formulation B | 0.59 | (c) | 2.48 | 226 |
| Formulation B | 0.44 | (a) | 2.00 | 113 |
| Formulation B | 0.44 | (b) | 1.58 | 128 |
| Formulation B | 0.44 | (c) | 2.97 | 234 |

*Object count may be lower than the actual due to particles in AFM image being “clumped” together.

It can be seen that diluted Formulations A and B spin-sprayed onto the control wafer having post-CMP residue thereon reduced the particle count by at least 90%. Importantly, the RMS roughness (nm) following, cleaning with the acidic compositions of the invention is less than 5 nm, preferably less than 4 nm, and most preferably less than 3 nm.

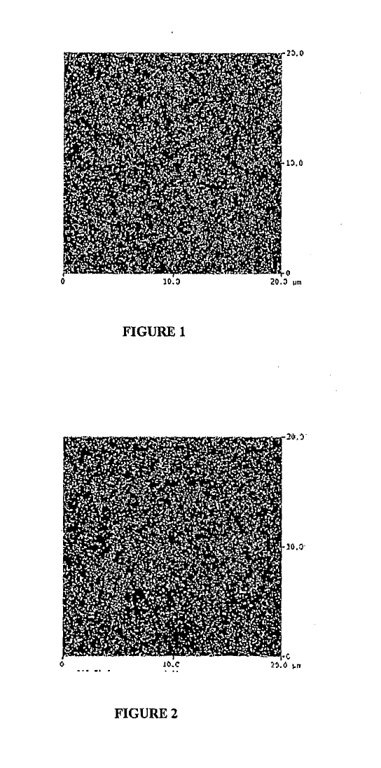

FIG. 1 is an AFM image of the Sematech 854 control wafer contaminated with post-CMP residue before cleaning the wafer with an acidic cleaning composition of the present invention.

FIG. 2 is an AFM image of the Sematech 854 wafer of FIG. 1 after cleaning the wafer with a 0.75% citric acid solution for comparison purposes.

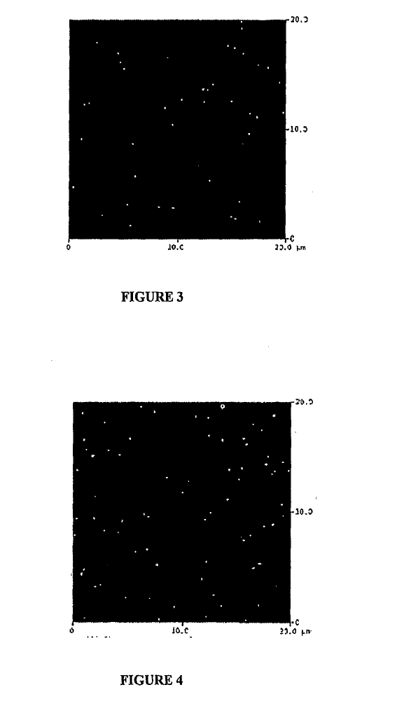

FIG. 3 is an AFM image of the Sematech 854 wafer of FIG. 1 after cleaning the wafer With the composition including 0.44 wt. % Formulation B.

FIG. 4 is an AFM image of the Sematech 854 wafer of FIG. 1 after cleaning the wafer with the composition, including 0.07 wt. % Formulation A.

It can be seen that diluted Formulations A and B efficaciously remove the post-CMP residue from the surface of the control wafer using the spin-spray method. Accordingly, it is expected that megasonic cleaning and brush scrubbing in the presence of the formulations of the invention will result in even more substantial cleaning in a shortened treatment period thereby reducing the cost of ownership of the device wafer.

Although the invention has been variously disclosed herein with reference to illustrative embodiments and features, it will be appreciated that the embodiments and features described hereinabove are not intended to limit the invention, and that other variations, modifications and other embodiments will suggest themselves to those of ordinary skill in the art, based on the disclosure herein. The invention therefore is to be broadly construed, as encompassing all such variations, modifications and alternative embodiments within the spirit and scope of the claims hereafter set forth.

1. An acidic composition comprising at least one surfactant, at least one dispersing agent, at least one sulfonic acid-containing hydrocarbon, and water, wherein said acidic composition is suitable for cleaning residue and contaminants from a microelectronic device having said residue and contaminants thereon.

2. (canceled)

3. The acidic composition of claim 1, further comprising at least one complexing agent.

4. (canceled)

5. (canceled)

6. The acidic composition of claim 3, wherein the weight percent ratio of complexing agent(s) relative to sulfonic acid-containing hydrocarbon(s) is in a range from about 10 to about 30.

7. The acidic composition of claim 1, wherein the at least one surfactant comprises a species selected from the group consisting of amphoteric salts, cationic surfactants, anionic surfactants, fluoroalkyl surfactants, non-ionic surfactants, and combinations thereof.

8. (canceled)

9. The acidic composition of claim 1, wherein the at least one surfactant comprises alkyl benzene sulfonic acid or dodecylbenzenesulfonic acid.

10. (canceled)

11. (canceled)

12. The acidic composition of claim 1, wherein the at least one dispersing agent comprises a low molecular weight acrylic acid-containing polymer selected from the group consisting of a acrylic acid homopolymer, an acrylic acid copolymer, and combinations thereof.

13. The acidic composition of claim 1, wherein the at least one sulfonic acid-containing hydrocarbon comprises a species selected from the group consisting of a straight chain C₁-C₆ alkane sulfonic acid, a branched C₁-C₆ alkane sulfonic acid, a straight chain C₁-C₆ alkene sulfonic acid, a branched C₁-C₆ alkene sulfonic acid, a substituted C₆-C₁₄ aryl sulfonic acid, a unsubstituted C₆-C₁₄ aryl sulfonic acid, and combinations thereof.

14. The acidic composition of claim 1, wherein the at least one sulfonic acid-containing hydrocarbon comprises a species selected from the group consisting of methanesulfonic acid, ethanesulfonic acid, propanesulfonic acid, butanesulfonic acid, pentanesulfonic acid, hexanesulfonic acid, ethenesulfonic acid, toluenesulfonic acid, salts thereof, and combinations thereof.

15. The acidic composition of claim 3, wherein the at least one complexing agent comprises an organic acid selected from the group consisting of lactic acid, maleic acid, ascorbic acid, malic acid, citric acid, benzoic acid, fumaric acid, succinic acid, oxalic acid, malonic acid, mandelic acid, maleic anhydride, phthalic acid, aspartic acid, glutamic acid, glutaric acid, glycolic acid, glyoxylic acid, itaconic acid, phenylacetic acid, quinic acid, pyromellitic acid, tartaric acid, terephthalic acid, trimellitic acid, trimesic acid, gluconic acid, glyceric acid, formic acid, acetic acid, propionic acid, acrylic acid, adipic acid, itaconic acid, glycine, lysine, pyrocatecol, pyrogallol, gallic acid, tannic acid, salts thereof, and combinations thereof.

16. (canceled)

17. (canceled)

18. The acidic composition of claim 1, having a pH in a range from about 0.05 to about 2.

19. (canceled)

20. The acidic composition of claim 1, further comprising post-CMP residue and contaminants.

21. The acidic composition of claim 1, comprising one of formulations A, B or C:
Formulation A: alkylbenzene sulfonic acid, polyacrylic acid and methanesulfonic acid;
Formulation B: dodecylbenzene sulfonic acid, polyacrylic acid and methanesulfonic acid; or
Formulation C: dodecylbenzene sulfonic acid, polyacrylic acid, methanesulfonic acid, and citric acid.

22. (canceled)

23. (canceled)

24. A kit comprising, in one or more containers, one or more of the following reagents for forming an acidic composition, said one or more reagents selected from the group consisting of at least one surfactant, at least one dispersing agent, at least one sulfonic acid-containing hydrocarbon, optionally at least one complexing agent, and water, and wherein the kit is adapted to form an acidic composition suitable for cleaning post-CMP residue and contaminants from a microelectronic device having said residue and contaminants thereon.

25. A method of cleaning residue and contaminants from a microelectronic device having said residue and contaminants thereon, said method comprising contacting the microelectronic device with an acidic composition for sufficient time to at least partially clean said residue and contaminants from the microelectronic device, wherein the acidic composition includes at least one surfactant, at least one dispersing agent, at least one sulfonic acid-containing hydrocarbon, and water.

26. (canceled)

27. The method of claim 25, wherein the acidic composition further comprises at least one complexing agent.

28. The method of claim 25, wherein said contacting comprises a condition selected from the group consisting of: time of from about 15 seconds to about 5 minutes; temperature in a range of from about 20° C. to about 50° C.; and combinations thereof.

29. (canceled)

30. The method of claim 27, wherein the weight percent ratio of complexing agent(s) relative to sulfonic acid-containing hydrocarbon(s) is in a range from about 10 to about 30.

31. The method of claim 25, wherein the at least one surfactant comprises a species selected from the group consisting of amphoteric salts, cationic surfactants, anionic surfactants, fluoroalkyl surfactants, non-ionic surfactants, and combinations thereof,
wherein the at least one dispersing agent comprises a low molecular weight acrylic acid-containing polymer selected from the group consisting of a acrylic acid homopolymer, an acrylic acid copolymer, and combinations thereof, and
wherein the at least one sulfonic acid-containing hydrocarbon comprises a species selected from the group consisting of a straight chain C₁-C₆ alkane sulfonic acid, a branched C₁-C₆ alkane sulfonic acid, a straight chain C₁-C₆ alkene sulfonic acid, a branched C₁-C₆ alkene sulfonic acid, a substituted C₆-C₁₄ aryl sulfonic acid, a unsubstituted C₆-C₁₄ aryl sulfonic acid, and combinations thereof.

32. (canceled)

33. The method of claim 25, wherein said composition has a pH in a range of from about 0.5 to about 2.

34.-37. (canceled)

38. The acidic composition of claim 20, wherein the post-CMP residue and contaminants comprise materials selected from the group consisting of particles from a CMP polishing slurry, chemicals present in the CMP polishing slurry, reaction by-products of the CMP polishing slurry, carbon-rich particles, polishing pad particles, copper, and copper oxides.
